(19) United States
(12) Patent Application Publication
(10) Pub. No.: US 2012/0163693 A1
(43) Pub. Date: Jun. 28, 2012

(54) Non-Invasive Imaging-Based Prostate Cancer Prediction

(76) Inventor: Jasjit S. Suri, Roseville, CA (US)

(21) Appl. No.: 13/412,118

(22) Filed: Mar. 5, 2012

Related U.S. Application Data
(63) Continuation-in-part of application No. 12/799,177, filed on Apr. 20, 2010.
Application No. 12/799,177 is a continuation-in-part of application No. 12/802,431, filed on Jun. 7, 2010.
Application No. 12/802,431 is a continuation-in-part of application No. 12/896,875, filed on Oct. 2, 2010.
Application No. 12/896,875 is a continuation-in-part of application No. 12/960,491, filed on Dec. 4, 2010.
Application No. 12/960,491 is a continuation-in-part of application No. 13/053,971, filed on Mar. 22, 2011.
Application No. 13/053,971 is a continuation-in-part of application No. 13/077,631, filed on Mar. 31, 2011.
Application No. 13/077,631 is a continuation-in-part of application No. 13/107,935, filed on May 15, 2011.
Application No. 13/107,935 is a continuation-in-part of application No. 13/219,695, filed on Aug. 28, 2011.
Application No. 13/219,695 is a continuation-in-part of application No. 13/253,952, filed on Oct. 5, 2011.
Application No. 13/253,952 is a continuation-in-part of application No. 13/407,602, filed on Feb. 28, 2012.
(60) Provisional application No. 61/525,745, filed on Aug. 20, 2011.

(51) Int. Cl. G06K 9/00

(52) U.S. Cl. 382/131

(57) ABSTRACT

A system (UroImage™) is an imaging based system for predicting if the prostate is cancerous or not using non-invasive ultrasound. The method is an on-line system where region of interest processor computes the capsule region in the Urological image. The feature extraction processor finds the significant features such as non-linear higher order spectra and high pass filter discrete wavelet based features, and combines them. The on-line classifier processor uses along with the training-based parameters to estimate and predicate if the patient's prostate is cancerous or not. The UroImage™ also introduces the applicability of this system for MR, CT or fusion of these modalities with ultrasound for predicting cancer.

### PRIORITY APPLICATIONS

This is a continuation-in-part patent application of co-pending patent application, Ser. No. 12/799,177; filed Apr. 20, 2010 by the same applicant. This is also a continuation-in-part patent application of co-pending patent application, Ser. No. 12/802,431; filed Jun. 7, 2010 by the same applicant. This is also a continuation-in-part patent application of co-pending patent application, Ser. No. 12/896,875; filed Oct. 2, 2010 by the same applicant. This is also a continuation-in-part patent application of co-pending patent application, Ser. No. 12/960,491; filed Dec. 4, 2010 by the same applicant. This is also a continuation-in-part patent application of co-pending patent application, Ser. No. 13/053,971; filed Mar. 22, 2011 by the same applicant. This is also a continuation-in-part patent application of co-pending patent application, Ser. No. 13/077,631; filed Mar. 31, 2011 by the same applicant. This is also a continuation-in-part patent application of co-pending patent application, Ser. No. 13/107,935; filed May 15, 2011 by the same applicant. This is also a continuation-in-part patent application of co-pending patent application, Ser. No. 13/219,695; filed Aug. 28, 2011 by the same applicant. This is also a continuation-in-part patent application of co-pending patent application, Ser. No. 13/253,952; filed Oct. 5, 2011 by the same applicant: This is also a continuation-in-part patent application of co-pending patent application, Ser. No. 13/407,602; filed Feb. 28, 2012 by the same applicant. This present patent application draws priority from the referenced co-pending patent applications. This present patent application also draws priority from the provisional patent application, Ser. No. 61/525,745; filed Aug. 20, 2011 by the same applicant. The entire disclosures of the referenced co-pending patent applications and the provisional patent application are considered part of the disclosure of the present application and are hereby incorporated by reference herein in its entirety.

### TECHNICAL FIELD

This application relates to a method and system for use with data processing and imaging systems, according to one embodiment, and more specifically, for enabling automated Cancer Prediction Imaging.

### BACKGROUND

Prostate gland is a chestnut shaped reproductive organ and is located underneath the bladder in men. This gland adds secretions to the sperms during the semen ejaculation. This gland envelops urethra, the tube or duct which serves a path for both semen and urine. The gland looks like a walnut and is rounded at top and tapers in the bottom called apex of the gland. This glad is about 4 cm in longitudinal direction.

Prostate cancer is a disease that grows, slowly and is confined to the prostate gland and may not cause a serious harm. These kinds of cancers may need minimal or no treatment. There are other types of prostate cancer that grows which can grow aggressively and can spread quickly and needs immediate attention.

We can classify the prostate cancer into both stages and grades. There are mainly two types of prostate cancer stages: (a) clinical stage of the prostate cancer and (b) pathological stage of the prostate cancer. In clinical stage of prostate cancer, the Urologist already has the information about the digital rectal exam (DRE), but they do not have information about the PSA or the Gleason score of the cancer. During the pathological stage of the prostate cancer, the lymph node or the prostate is taken out of the body and a doctor can make a more accurate inference about the cancer, which helps in making an accurate prognosis.

Prostate Cancer is one of the most common cancers in men in USA. It is also one of the leading causes of death in men for all races. In 2007, 223,307 men in the US alone were diagnosed with prostate cancer. In all, 29,093 men in the United States died from prostate cancer. On Cancer Prostate screening, Digital Rectal Examination (DRE) and Prostate-Specific Antigen (PSA) testing have been commonly adapted. For details for the guide to the prostate cancer, following publication can be used for details (M. N. Simmons, R. K. Berglund, and J. S. Jones, “A practical guide to prostate cancer diagnosis and management,” Cleve. Clin. J. Med. 78, 321-331 (2011)).

Today, Prostate specific antigen (PSA) test is one of the standard screening tools for detection of prostate cancer. A patient having a high PSA level or a rising PSA density is usually the first signs for a prostate cancer. PSA is actually an enzyme that the body uses to turn the semen into the liquid which has been congealed after ejaculation. (More information about PSA test and PSA can be seen in this publication: R. M. Hoffman, F. D. Gilliland, M. Adams-Cameron, W. C. Hunt, and C. R. Key, “Prostate-specific antigen testing accuracy in community practice,” BMC Fam. Pract. 24, 3:19 (2002)). Some of the PSA will enter into the blood stream. Doctors, who use PSA to test for prostate cancer, use PSA as a marker for tumors. In case of a swollen prostate, a PSA may be higher because it is bigger. A high PSA does not necessarily indicate prostate cancer, but can cause a PBH or prostatitis.

Both DRE and PSA have weakness that it lacks specificity and hence patients have to undergo unnecessary biopsies. Several other biomarkers are used today since PSA is not a reliable marker for detecting prostate cancer. The publication by Sardana shows emerging biomarkers for diagnosis of prostate cancer (G. Sardana, B. Dowell, and E. P. Diamandis, “Emerging biomarkers for the diagnosis and prognosis of prostate cancer,” Clin. Chem. 54, 1951-1960 (2008)).

Several imaging based methods are used today to tell the difference between a benign and malignant cancers. An example can be elastography-based system. An example of elastography-based system can be seen in the following publication (K. Konig, U. Scheipers, A. Pesavento, A. Lorenz, H. Ermert, and T. Senge, “Initial experiences with real-time elastography guided biopsies of the prostate,” J. Urol. 174, 115-117 (2005)).

MRI-based system has been adapted for cancer detection. An example of MRI-based cancer detection system can be seen in the following publication (S. D. Heenan, “Magnetic resonance imaging in prostate cancer,” Prostate Cancer Prostatic Dis. 7, 282-288. (2004)). Other imaging modalities re CT-based or intravenous contrast enhancement-based. Details can be seen using CT-based system (E. P. Ives, M. A. Burke, P. R. Edmonds, L. G. Gomella, and E. J. Halpern, “Quantitative CT perfusion of prostate cancer: correlation with whole mount pathology,” Clin. Prostate Cancer 4, 109-112 (2005) and (G. Brown, D. A. Macvicar, V. Ayton, and J. E. Husband, “The role of intravenous contrast enhancement in magnetic resonance imaging of prostatic carcinoma,” Clin. Radiol. 50, 601-606 (1995)). The works described in these papers use imaging-based system but no tissue characterization system for distinguishing benign vs. malignant prostate tissue. Thus, neither the PSA level nor the imaging-based system is a fool proof system for diagnosis of prostate cancer.

### SUMMARY

This invention uses an imaging-based non-invasive method for detecting the benign vs. malignant cancer tissues in prostate. Further since no one modality provides the complete solution to prostate cancer detection, this innovative application uses fusion of modalities to characterize the tissue and then classify it into benign and malignant tissue. This paradigm takes the advantage of a novel system design called “UroImage™” which fundamentally be applied with unique imaging scanner such as 2D ultrasound or 3D ultrasound or other imaging modalities like MR or CT or its inter-fusion methods. Further, this invention allows to use the “UroImage™” system in mobile settings where the three tier system (presentation layer, business layer and database management layer) can be adapted both on a tablet (such as Samsung) or a one tier (presentation layer) system can be adapted on tablet and the remaining two tiers (business layer and database management layer) in the cloud.

### BRIEF DESCRIPTION OF THE DRAWINGS

The various embodiments is illustrated by way of example, and not by way of limitation, in the figures of the accompanying drawings in which:

FIG. 1 illustrates an example of UroImage™ system.

FIG. 2 shows an illustrative example of Scan and Capsule feature processor.

FIG. 3 shows an illustrative example of Capsule Feature processor.

FIG. 4 shows an illustrative example of Normal Scan Data.

FIG. 5 shows an illustrative example of Cancerous Scan Data.

FIG. 6 shows an illustrative example of Regional Feature Processor.

FIG. 7 shows an illustrative example of Classification Processor using Decision Tree Base system.

FIG. 8 shows an illustrative example of Classification Processor using Fuzzy classification system.

FIG. 9 shows an illustrative example of Classification Processor using Neural Net Based system.

FIG. 10 shows an illustrative example of Classification Processor using Gaussian Mixture model based system.

FIG. 11 shows an illustrative example of UroImage™ using MR based system.

FIG. 12 shows an illustrative example of UroImage™ using CT based system.

FIG. 13 shows an illustrative example of UroImage™ used under the fusion mode of MR and CT.

FIG. 14 shows an illustrative example of UroImage™ used under the fusion mode of MR and Ultrasound.

FIG. 15 shows an illustrative example of UroImage™ using the performance evaluation processor.

FIG. 16 shows an illustrative example of UroImage™ features of cancerous and non-cancerous tissues computed in the region of interest.

FIG. 17 shows an illustrative example of UroImage™ performance evaluation processor using different set of classification processor.

FIG. 18 shows an illustrative example of UroImage™ application used in the mobile settings where the processor has all the three tiers.

FIG. 19 shows an illustrative example of UroImage™ application used in the mobile settings where tier one is on the tablet and the other two tiers are configured in the cloud.

FIG. 20 shows an entire system.

FIG. 21 shows a diagrammatic representation of machine in the example form of a computer system within which a set of instructions when executed may cause the machine to perform any one or more of the methodologies discussed herein.

### DETAILED METHODOLOGY OF THE SYSTEM OF AN EXAMPLE EMBODIMENT

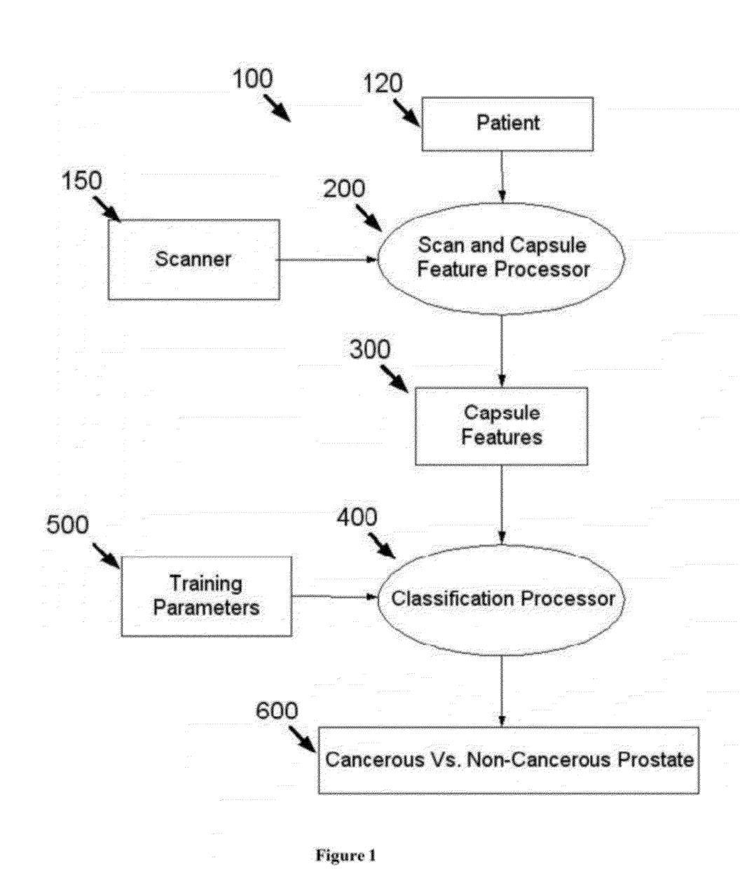

FIG. 1 illustrates block 100 as an example of UroImage™ system. It consists of scan and capsule feature processor block 200. Processor 200 is connected to the block 150 for scanning the prostate. Processor 400 is used for computing and predicting if the patient is cancerous or not. Processor 400 requires the pre-determined training parameters. This is an online system where the patient 120 is the test patient and undergoes the scanning of the prostate. The UroImage™ does not require if the patient have had the PSA test or not. It further does not require if the patient have had MRI or CT or contrast enhanced ultrasound.

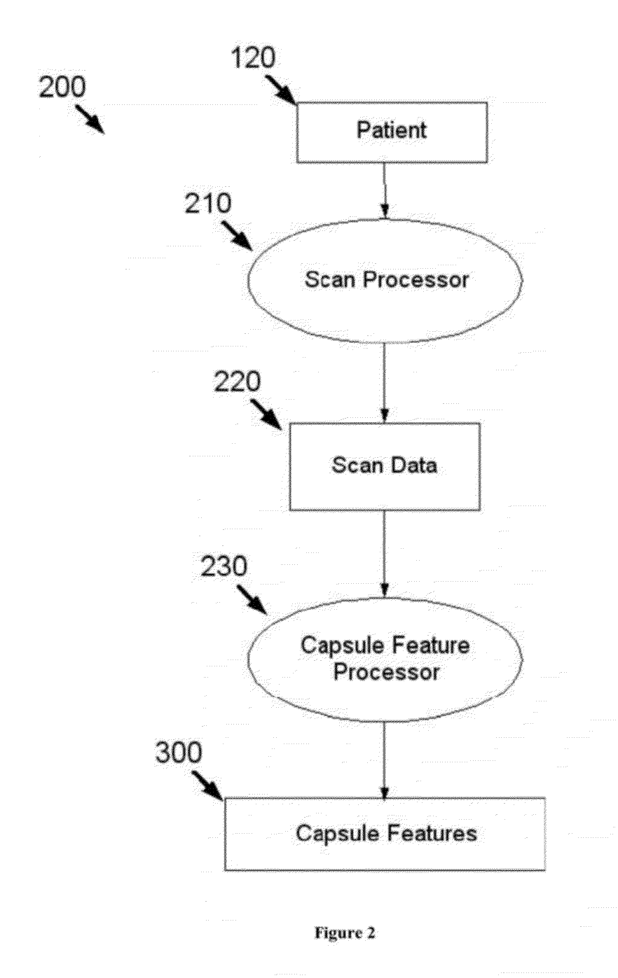

FIG. 2 shows an illustrative example of Scan and Capsule feature processor block 200. Processor 210 is used for scanning the prostate using the conventional scanning system. It can be a 2D method or a 3D ultrasound scanning method. Those skilled in the art will know the protocol for scanning the prostate in two different positions: (a) transverse or axial scan and (b) longitudinal scan. Those skilled in the art of MRI can use the standard T1-weighted, T2-weighted or PD scans for the prostate. Those skilled in the CT acquisition can use the standard CT image acquisition protocol for the prostate scan. Block 220 shows the scan data output using the scan processor. Note that the scan processor protocol used on the test patient must adapt the same scan protocol when using method for generating the training parameters. Block 230 shows the capsule feature processor which is used for computing the feature of the prostate gland or capsule. The output is the capsule features 300.

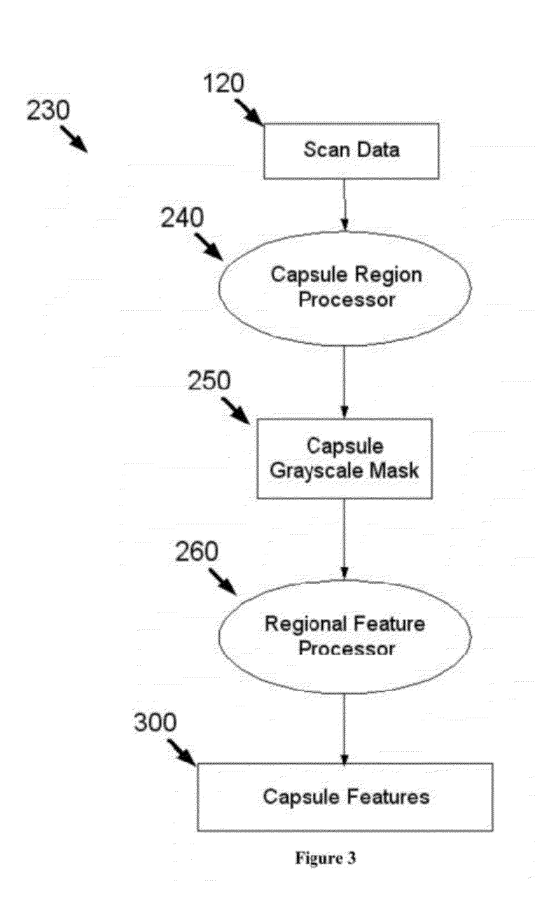

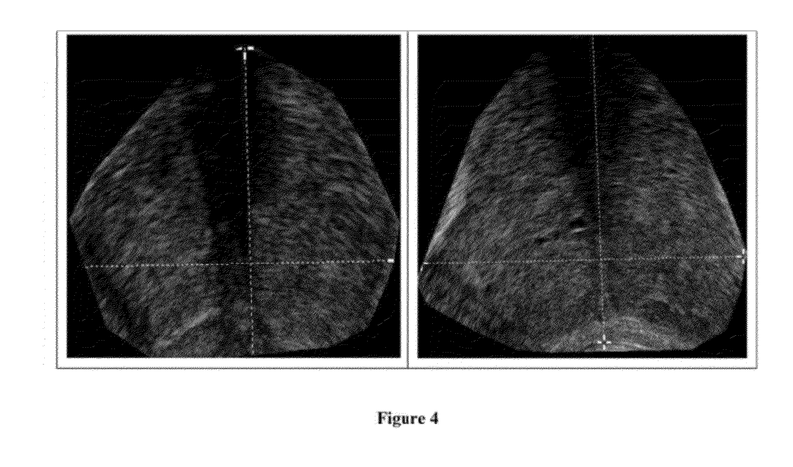

FIG. 3 shows an illustrative example of Capsule Feature processor 230. The processor 230 consists of sub-processors capsule region processor 240 and regional feature processor 260. The processor 240 gives the grayscale mask region 250. Those skilled in the art of image segmentation can use methods developed in (A new 3D automated segmentation of prostate from CE-MRI, A. Firjani, A. Elnakib, F. Khalifa, G. Gimel'farb, M. Abo El-Ghar, J. Suri, A. Elmaghraby, and A. El-Baz, IEEE International Symposium on Biomedical Imaging, 2011, DOI: 10.1109/ISBI.2011.5872679 or techniques using deformable models in book of Deformable models: by—Jasjit S. Suri and Aly Farag, “deformable models: BIOMEDICAL AND CLINICAL APPLICATIONS, VOLUME-II, in Springer, 2006). FIG. 4 shows an illustrative example of block 250. Those skilled in the art can use the longitudinal image or transverse image or 3D image for capsule grayscale mask generation. Those skilled in the area of segmentation can use semi-automated method which combines a computer algorithm and the tracer who traces the points which are not correctly segmented.

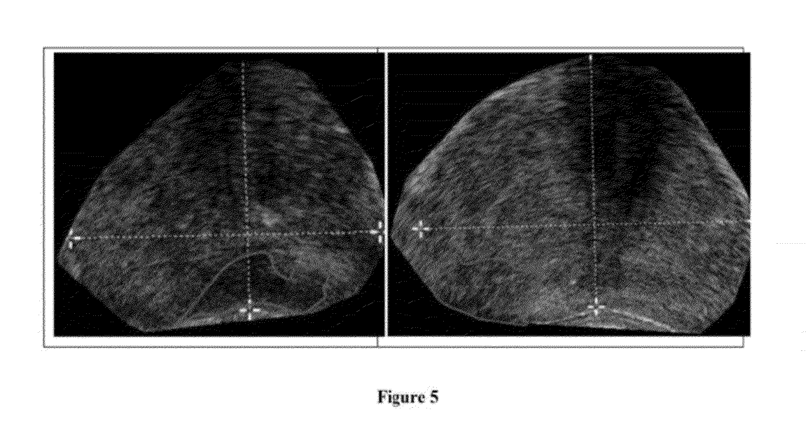

FIG. 5 shows an illustrative example of Cancerous Scan Data. On the left and right are the hypo-echoic regions representing the cancerous zones in the transverse image of the capsule. The white dotted lines are the horizontal and vertical lines representing the largest length in transverse direction (so called the width of the prostate) and largest length representing the height of the capsule. Those skilled in the art can determine the hypo-echoic regions and validate this by the biopsy for the training system if required.

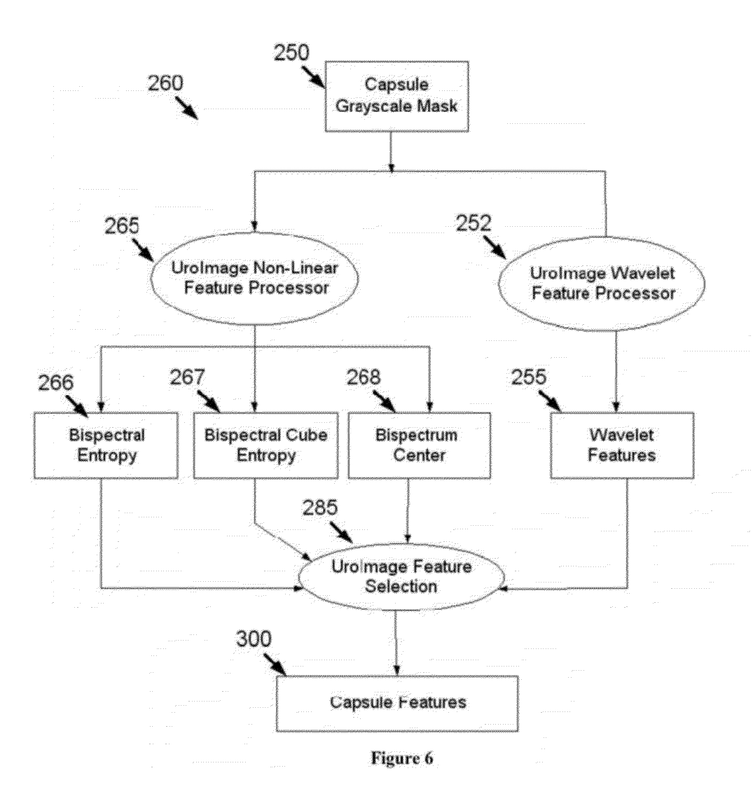

FIG. 6 shows an illustrative example of Regional Feature Processor. This block is used for computing the grayscale characteristics of the pixels in the grayscale scale mask. Those skilled in the art can also use the grayscale region delineated by the Urologist or a medical doctor. Block 260 inputs the grayscale region as input to this sub-system and computes different kinds of features such as non-linear features using non-linear processor 265 and wavelet based features using the block 252: Non-linear processor bi-spectral entropy 266, bi-spectral cube entropy 267 and bi-spectrum center 268. An illustrative example of non-linear based processing can be seen in the following two publications (K. C. Chua, V. Chandran, U. R. Acharya, and C. M. Lim, “Cardiac state diagnosis using higher order spectra of heart rate variability,” J. Med. Eng. Technol. 32, 145-155 (2006) and K. C. Chua, V. Chandran, U. R. Acharya, and C. M. Lim, “Cardiac health diagnosis using higher order spectra and Support Vector Machine,” Open Med. Inform. J. 3, 1-38 (2009)). Processor 285 then combines the wavelet-based features 255 and output 266, 267 and 268. The feature selection procedure 285 selects the best features 300, which are then used for predicting if the prostate is cancerous or not.

Processor 252 uses the concept of wavelet transform, where the wavelet ψ_{a,b}(t) is given by

$$W ( i , j ) = {\int }_{∞}^{∞} \frac{f ( t ) 1}{\sqrt{\vert a \vert}} ψ \frac{( t - b )}{a}$$

where, “a” is the scale factor (related to dilation or compression of wavelet) and b is the translation factor (related to shifting of the wavelet). The grayscale image 250 is decomposed into different scales by successive low and high pass filters. High pass filter coefficients at level 2 decomposition (h2) are used to collect sudden changes in the cancerous image.

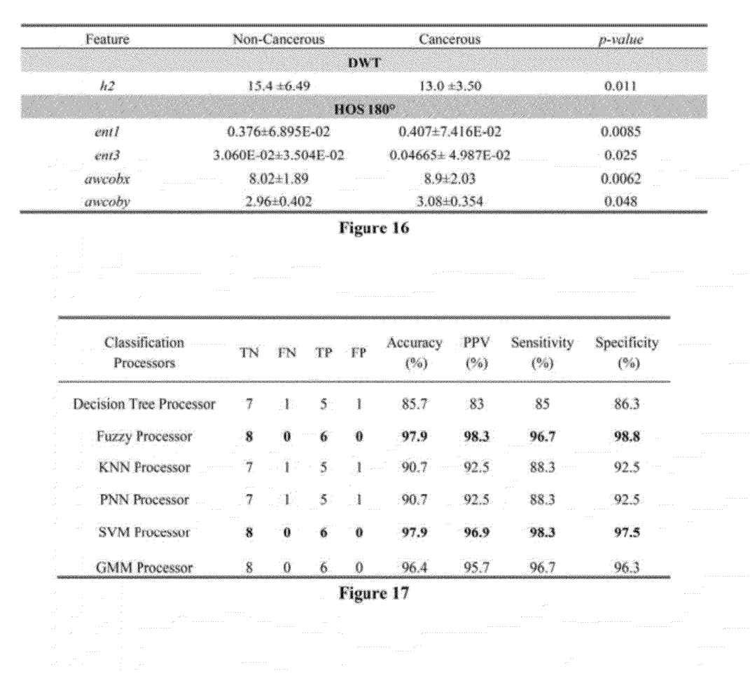

Processor 285 is used for extracting features by finding the p-value using Student's t-test. Those skilled in the art can use other statistical methods published in the article (J. F. Box, “Guinness, gosset, fisher, and small samples,” Statist. Sci. 2, 45-52 (1987)). FIG. 16 shows an illustrative example of UroImage™ features of cancerous and non-cancerous tissues computed in the region of interest. The difference in h2 features between cancerous and non-cancerous is shown in FIG. 16. The Higher order spectra feature between the cancerous tissue and non-cancerous tissues is shown in the lower part of the FIG. 16.

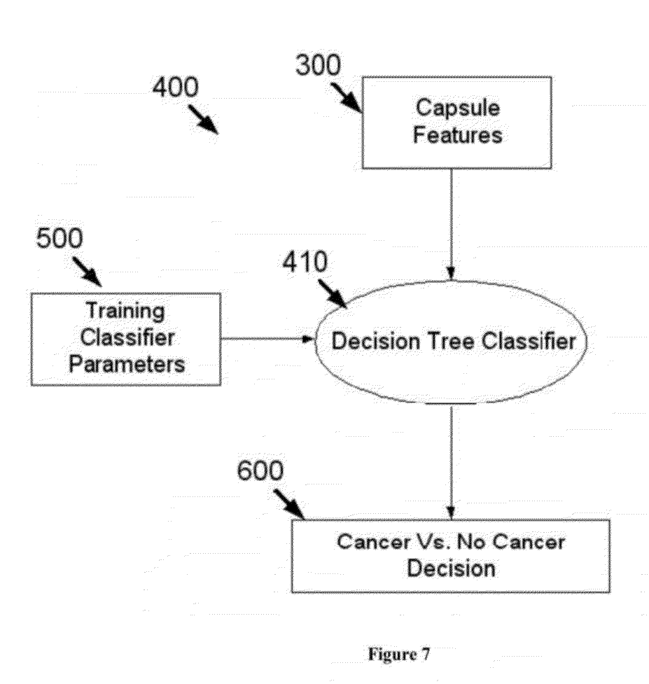

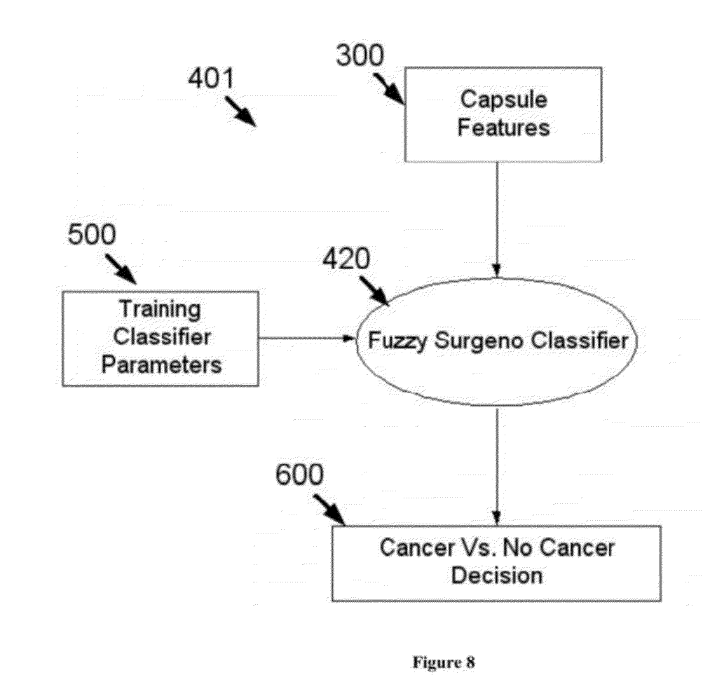

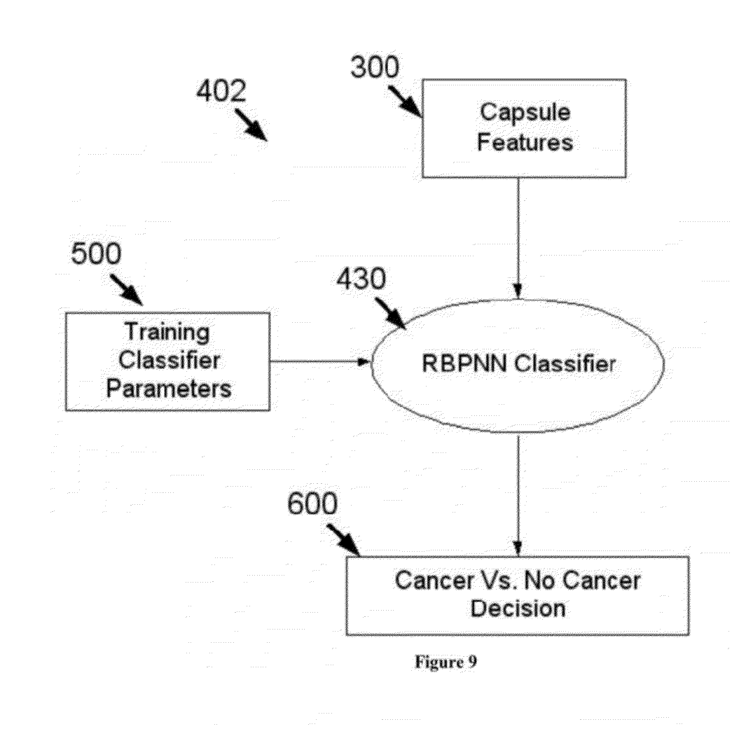

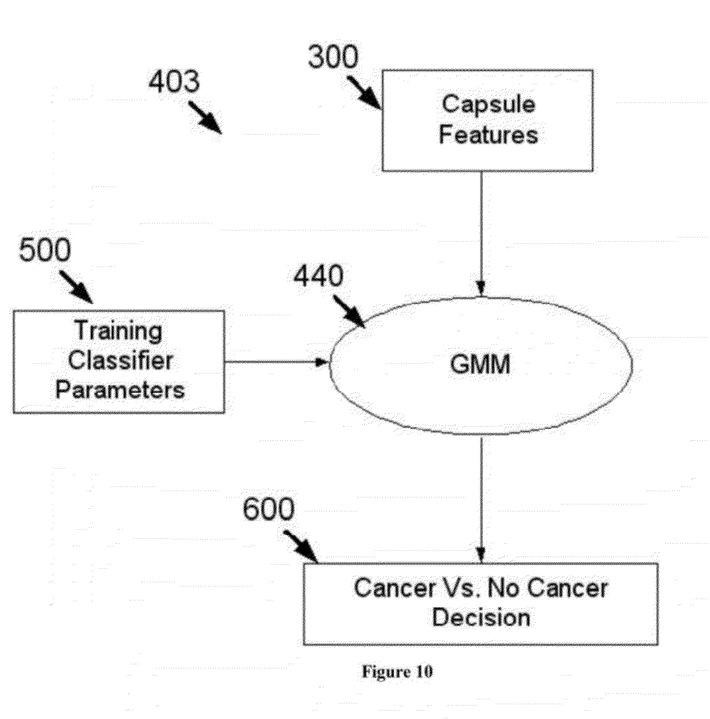

FIG. 7 shows an illustrative example of Classification Processor 400 using Decision Tree Base system 410. Processor 400 utilizes the block 500 that uses training-based parameters. The decision tree based classifier processor is a standard method adapted for computing the binary output 600 which report if the image is cancerous or not. Those skilled in the art of classification process can use SVM-based classification processor. Those skilled in the art can use the fuzzy classification processor 420. Processor 401 is the processor in FIG. 8 what uses Fuzzy Processor 420 for predicting if the patient prostate is cancerous or not. Processor 420 will also use the same training parameters as adapted by the processor 410. FIG. 9 shows an illustrative example of Classification Processor using Neural Net Based system. FIG. 10 shows an illustrative example of Classification Processor using Gaussian Mixture model based system.

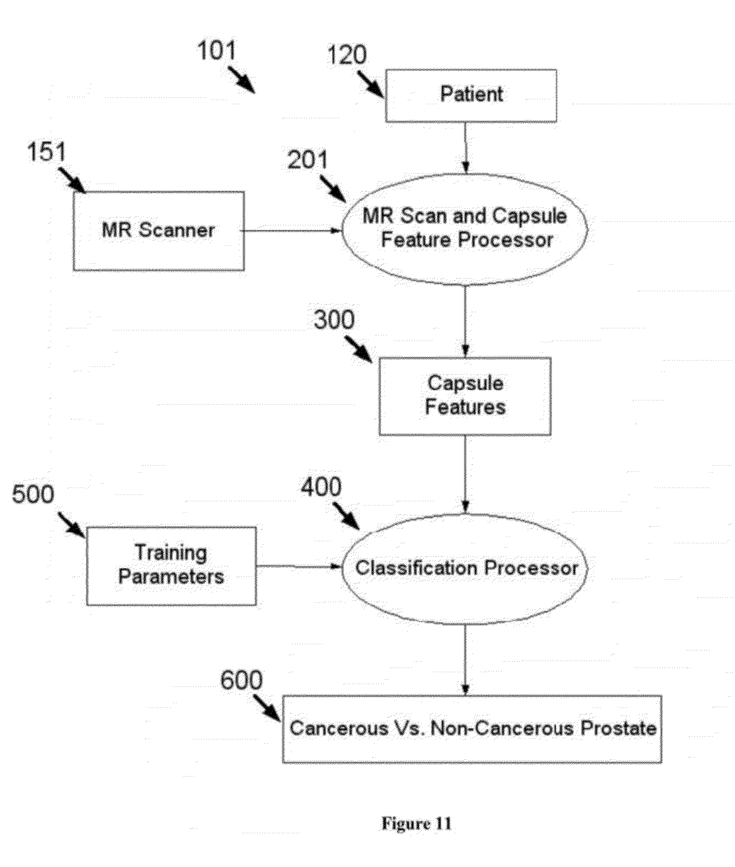

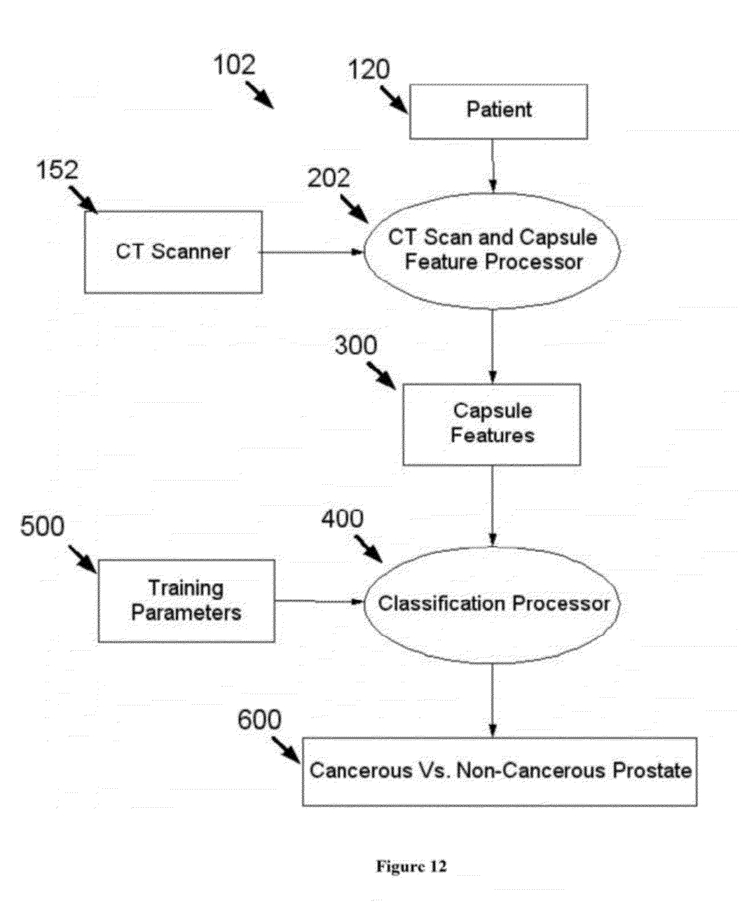

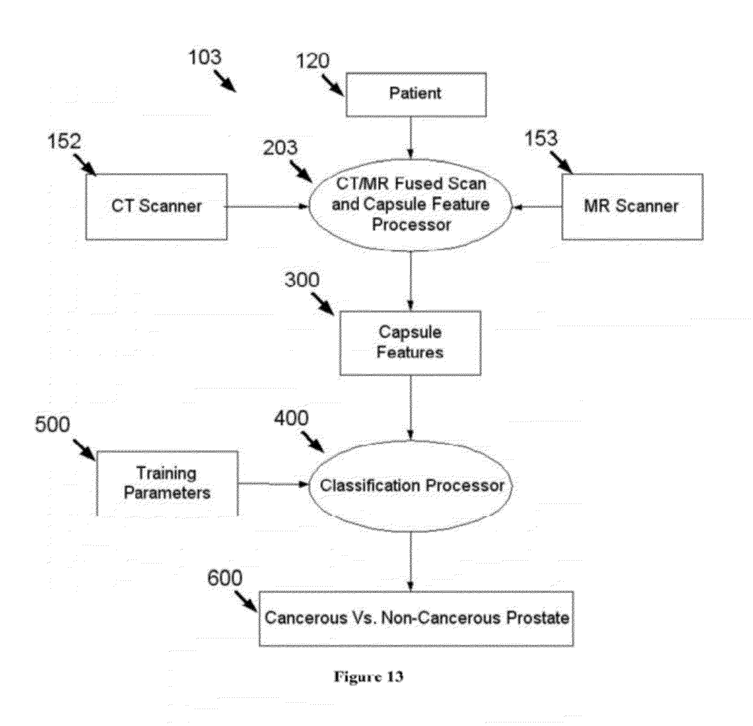

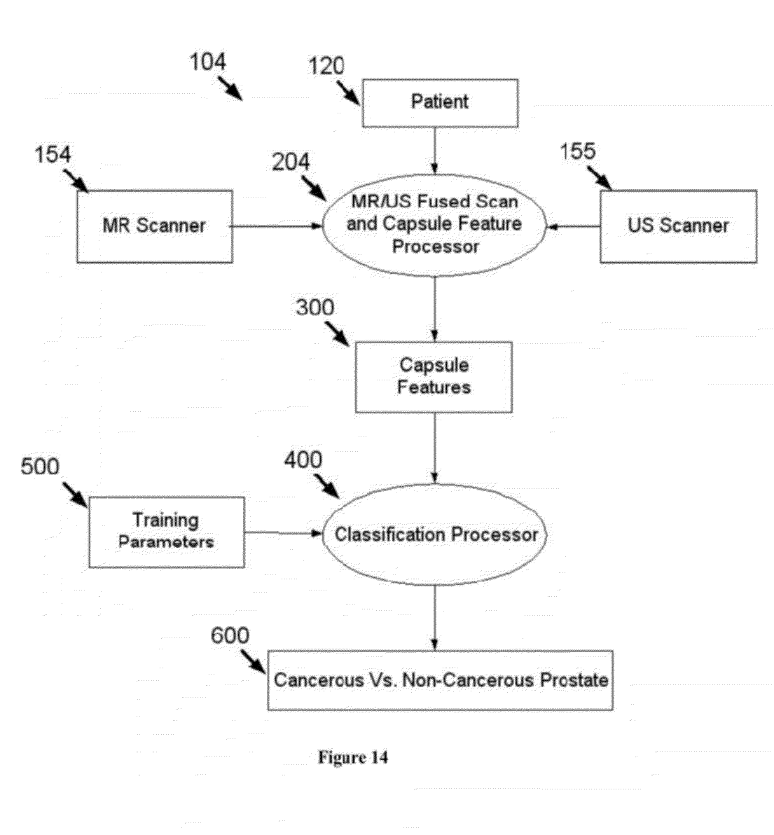

FIG. 11 shows an illustrative example of UroImage™ using MR as a scanner. Processor 201 is the MR scan and Capsule Feature Processor which outputs capsule features 300. The Classification processor 400 uses these features to predict the prostate to be cancerous or no cancerous output 600. FIG. 12 shows an illustrative example of UroImage™ using CT based system. FIG. 13 shows an illustrative example of UroImage™ used under the fusion mode of MR and CT. FIG. 14 shows an illustrative example of UroImage used under the fusion mode of MR and Ultrasound.

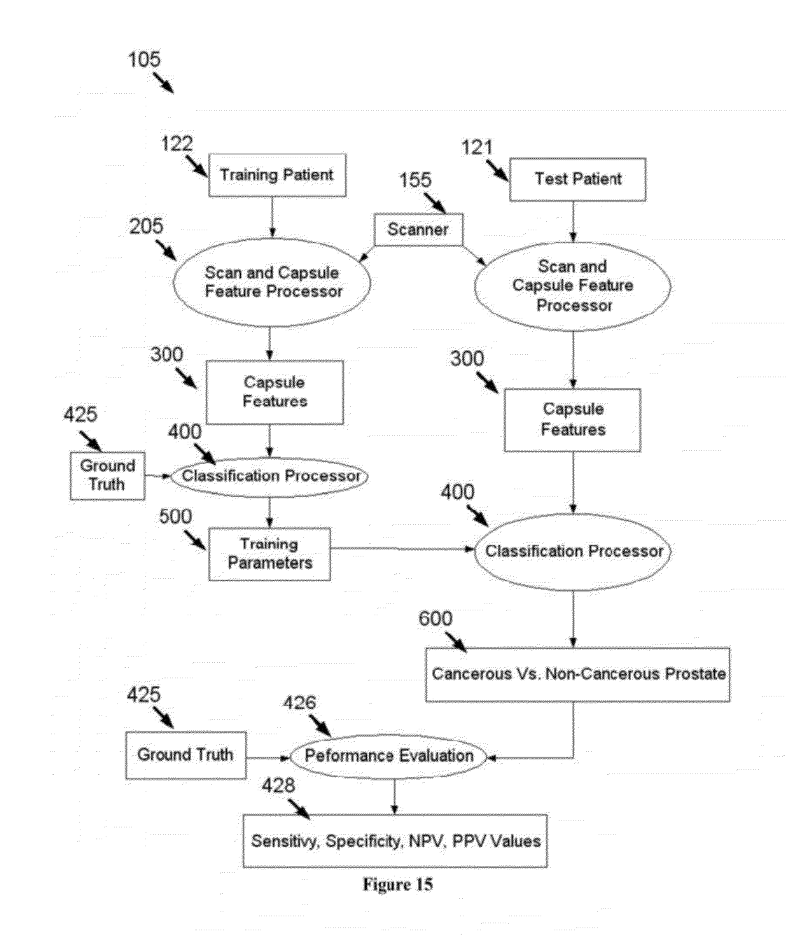

FIG. 15 shows an illustrative example of UroImage™ using the performance evaluation processor. Such a system is used when the patient population is large and we need to partition the data set for training and testing. Such a protocol is adapted when we need to evaluate the performance of the UroImage™ system. An illustrative example of FIG. 15 shows that data can be partitioned into K parts called as K-fold cross-validation. During the training phase (left half of the block 105), training parameters 500 are obtained using K-1 patient sets. The testing is done on first set. The procedure is then repeated for K-1 times with different test set each time. The overall performance is computed as the average of the measures obtained using K-folds. Those skilled in art can use different sets of K values.

The prediction output 600 is fed to the performance evaluation block 426. The performance of UroImage™ consists of calculating the measures like sensitivity, specificity, PPV and accuracy. Defining the abbreviations TN, FN, TP and FP as True Negative, False Negative, True Positive, False Positive and defining as follows: TN (True Negative) be the number of non-cancerous cases identified as non-cancerous, FN (False Negative) be the number of cancerous cases incorrectly identified as non-cancerous, TP (True Positive) be the number of cancerous cases correctly identified as they are, and FP (False Positive) be the number of non-cancerous cases incorrectly identified as cancerous. Using these, Sensitivity is computed as the probability that a classifier will produce a positive result when used on cancer population (TP/(TP+FN)). Specificity is the probability that a classifier will produce a negative result when used on the non-cancerous population (TN/(TN+FP)). Accuracy is the ratio of the number of correctly classified samples to the total number of samples ((TP+TN)/(TP+FN+TN+FP)). PPV is the proportion of patients with positive results who are correctly diagnosed (TP/(TP+FP)). FIG. 17 shows an illustrative example of identification of cancerous vs non-cancerous prostates (using K=10 cross-validation protocol). The example shows different sets of Classifier Processors used. The UroImage™ system shows six different kinds of classification processors. These illustrative example shows classifier performance using decision tree processor, fuzzy processor, KNN processor, PNN processor, SVM processor and GMM processor.

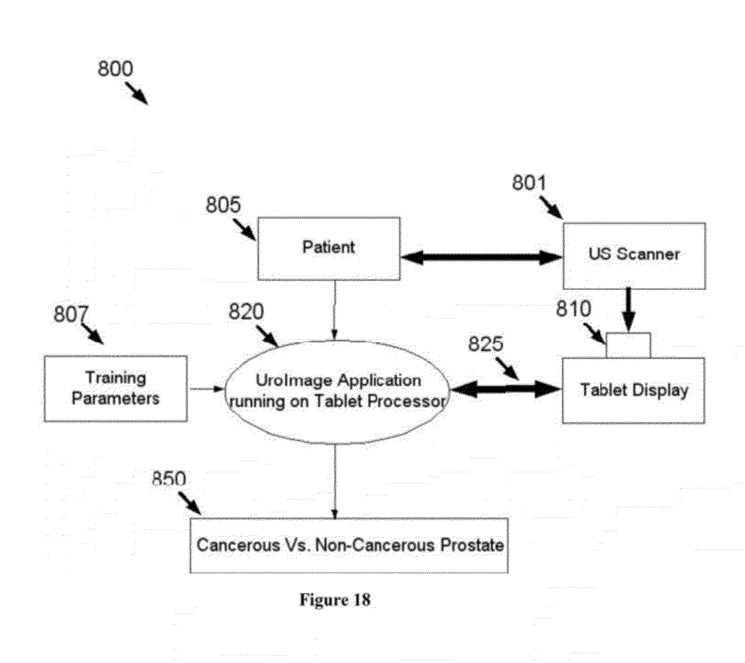

FIG. 18 shows an illustrative example of UroImage™ application used in the mobile settings where the processor has all the three tiers: (a) presentation layer; (b) business layer; (c) database management layer. Presentation layer runs using the processor 820 but uses block 810 for the display of the results. The block connector 810 receives the scanner data directly from the US scanner 801 using a unidirectional flow. The flow 825 is bi-directional where the data from between the display unit (tier 1) and business layer (tier 2) and DBMS layer (tier 3) running in the processor 820. The UroImage™ system uses training parameters 807 as an input to the three tier system 820.

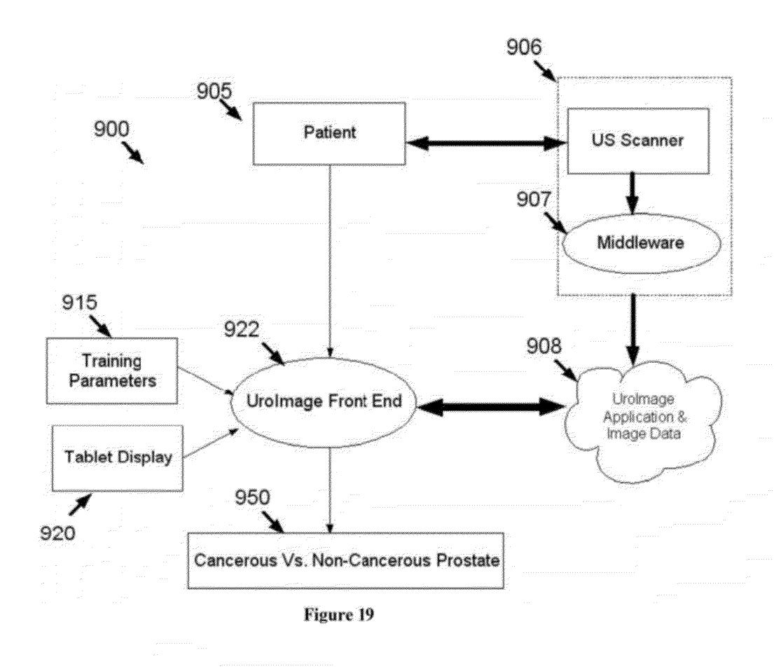

FIG. 19 shows an illustrative example of UroImage™ application used in the mobile settings where tier one is on the tablet and the other two tiers are configured in the cloud.

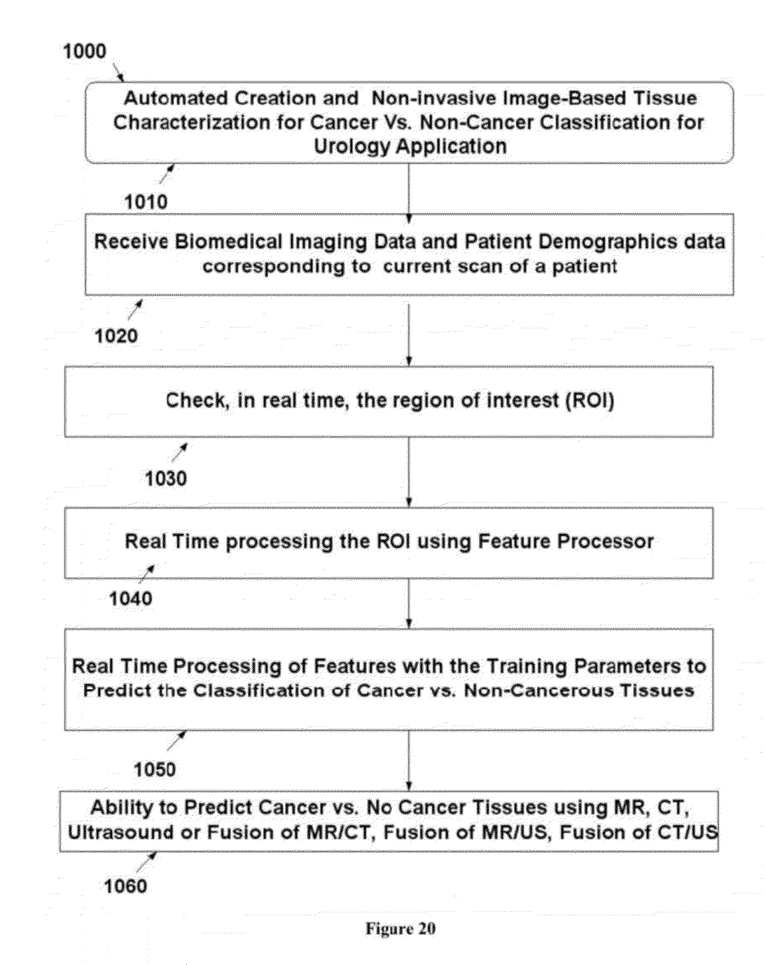

FIG. 20 shows an entire system. Block 1000 shows an illustrative example for automated identification of patients with prostates which are cancerous and which are not. This uses the concept of tissue characterization using non-invasive imaging based non-linear method combined with wavelet-based decomposition. Block 1020 shows that this can be applicable to prostate. TRUS image. Block 1030 is the region of interest determination. Block 1040 uses the non-linear dynamics combined with wavelet decomposition to extract the necessary distinguishing features of cancer vs. non-cancerous. Block 1050 uses the classification processor combined with the training parameters and Block 1060 uses a prediction method for labeling the prostate tissue to be cancerous or non-cancerous.

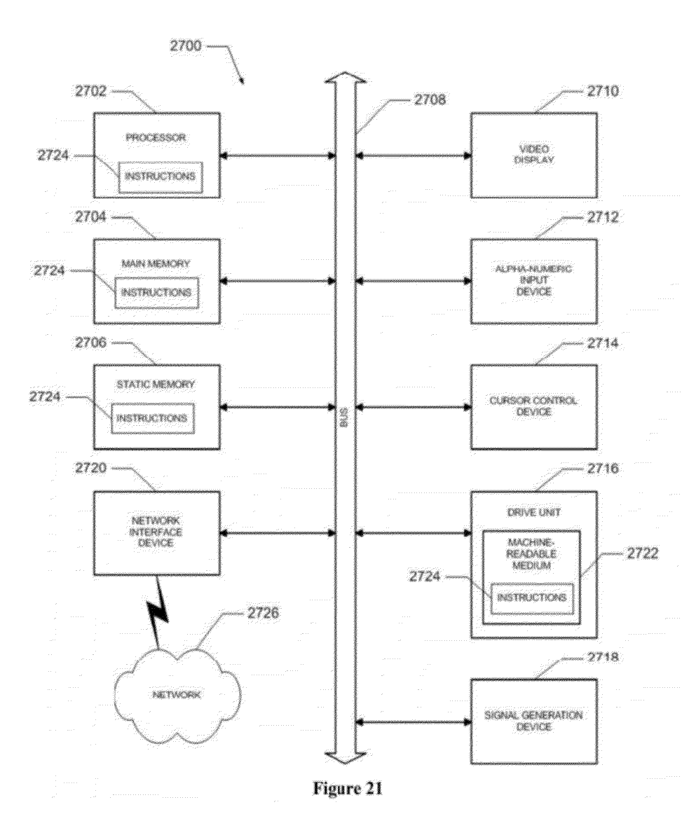

FIG. 21 shows a diagrammatic representation of machine in the example form of a computer system 2700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 2700 includes a processor 2702 (e.g., a central processing unit (CPU), a graphics processing unit (GPU), or both), a main memory 2704 and a static memory 2706, which communicate with each other via a bus 2708. The computer system 2700 may further include a video display unit 2710 (e.g., a liquid crystal display (LCD) or a cathode ray tube (CRT)). The computer system 2700 also includes an input device 2712 (e.g., a keyboard), a cursor control device 2714 (e.g., a mouse), a disk drive unit 2716, a signal generation device 2718 (e.g., a speaker) and a network interface device 2720.

The disk drive unit 2716 includes a machine-readable medium 2722 on which is stored one or more sets of instructions (e.g., software 2724) embodying any one or more of the methodologies or functions described herein. The instructions 2724 may also reside, completely or at least partially, within the main memory 2704, the static memory 2706, and/or within the processor 2702 during execution thereof by the computer system 2700. The main memory 2704 and the processor 2702 also may constitute machine-readable media. The, instructions 2724 may further be transmitted or received over a network 2726 via the network interface device 2720. While the machine-readable medium 2722 is shown in an example embodiment to be a single medium, the term “machine-readable medium” should be taken to include a non-transitory single medium or multiple media (e.g., a centralized or distributed database, and/or associated caches and servers) that store the one or more sets of instructions. The term “machine-readable medium” can also be taken to include any medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented UroImage™ method comprising:
receiving image data corresponding to a current scan of a patient;
using a data processor to process the biomedical imaging data corresponding to the current scan and to compute the region of interest;
using a data processor for computing the non-linear tissue features corresponding to the region of interest;
using a data processor for computing high pass filter features using Discrete Wavelet Transform corresponding to the region of interest;
using a data processor for combining the non-linear features and Discrete Wavelet Transform corresponding to the region of interest;
using a data processor for predicting the patient's tissue to be cancerous or non-cancerous.

2. The method as claimed in claim 1 wherein the current scan of the patient is: two-dimensional (2D) longitudinal and transverse B-mode ultrasound images or two-dimensional (2D) longitudinal and transverse radio frequency (RF) ultrasound images.

3. The method as claimed in claim 1 where in the UroImage™ system can automated predict the cancer vs. no cancerous tissue.

4. The method as claimed in claim 1 where in the UroImage™ system can compute the region of interest automatically or semi-automatically or manually.

5. The method as claimed in claim 1, where in the UroImage™ system can compute the non-linear features for tissue characterization.

6. The method as claimed in claim 1, where in the UroImage™ system can compute the non-linear features using higher order spectra for tissue characterization.

7. The method as claimed in claim 1, where in the UroImage™ system can compute the discrete wavelet based features for tissue characterization.

8. The method as claimed in claim 1, where in the UroImage™ system compute the features and select the best features and then combine them.

9. The method as claimed in claim 1, where in the UroImage™ system use the on-line features along with the training-parameters to predict the cancerous tissue.

10. The method as claimed in claim 1 where in UroImage™ can be used in any mobile system settings where, the acquired images can be stored in the cloud and displayed on the mobile unit (such as iPad or Samsung Tablets).

12. The method as claimed in claim 1 where in the receiving image data corresponding to a current scan of a patient can be from MR scanner and the same UroImage™ system be applied for predicting cancer.

13. The method as claimed in claim 1 where in the receiving image data corresponding to a current scan of a patient can be from CT scanner and the same UroImage™ system be applied for predicting cancer.

14. The method as claimed in claim 1 where in the receiving image data corresponding to a current scan of a patient can be from CT and MR scanner jointly and the data can be fused and then UroImage™ system be applied for predicting cancer.

15. The method as claimed in claim 1 where in the receiving image data corresponding to a current scan of a patient can be from CT and Ultrasound or MR with Ultrasound fusion data for using UroImage™ system be predict cancer.

16. The method as claimed in claim 1 where the Classification Processor can be a decision tree or support vector machine for predicting cancer.

17. The method as claimed in claim 1 where the Classification Processor can be a Fuzzy Classifier for predicting cancer.

18. The method as claimed in claim 1 where the Classification Processor can be a Gaussian Mixture Model (GMM) for predicting cancer.

19. The method as claimed in claim 1 where the Classification Processor can be a Neural Network Based Classifier for predicting cancer.

20. The method as claimed in claim 1 can using a cross-validation protocol for automatically computing performance measures sensitivity, specificity, PPV, NPV values.
